(19) United States
(12) Patent Application Publication
(10) Pub. No.: US 2004/0037064 A1
(43) Pub. Date: Feb. 26, 2004

(54) Apparatus for continuously sweeping a light source

(75) Inventor: George D. Johnson, Torrance, CA (US)

Correspondence Address: Richard P. Berg, ESQ., c/o LADAS & PARRY, Suite 2100, 5670 Wilshire Boulevard, Los Angeles, CA, 90036-5679, US

(73) Assignee: L.P. ASSOCIATES, INC.

(21) Appl. No.: 10/452,323

(22) Filed: May 30, 2003

Related U.S. Application Data
(60) Provisional application No. 60/385,190, filed on May 30, 2002.

(51) Int. Cl. F21V 21/30; F21V 21/28

(52) U.S. Cl. 362/35; 362/275; 362/284; 362/419

(57) ABSTRACT

The present invention provides an apparatus for a continuously rotatable light source. The present invention provides a light fixture assembly which houses a light source having a light source axis. A drive cage is coupled to the light fixture assembly to adjust the angle of the light source. The drive cage is rotatably coupled to a base unit to continuously sweep the light source about a generally vertical axis of a base unit. An anti-rotational assembly comprised of a plurality of u-joints is also provided. The anti-rotational assembly prevents the light source from rotating about the light source axis with respect to the base unit, while the light source is swept about the generally vertical axis of the base unit.

### CROSS-REFERENCE TO RELATED APPLICATIONS

The present document claims the benefit of U.S. Provisional Application No. 60/385,190, filed May 30, 2002, the contents of which are incorporated by reference herein.

### FIELD

The present invention relates to an electrically powered apparatus which can continuously sweep a light source at a variable angle about an axis without using slip rings to supply power and simultaneously minimize stress on the electrical wires powering the light source.

### BACKGROUND

Often during the opening ceremony of a large event, it is desirable to shine bright lights into the air highlighting the event. Typically, a high powered spotlight is used to accomplish this goal. Some spotlights are fixedly mounted so as to shine light in the same direction. Other spotlights are mounted so that they can rotate to form different patterns with the light.

One such spotlight that can rotate, is the moving beam searchlight sold under the tradename SKYDANCER. Another such spotlight is disclosed in U.S. Pat. No. 4,344,117 to Niccum. Both the moving beam searchlight and the Niccum spotlight have a light source located on a fixedly bent shaft. The shaft rotates the spotlight and due to the bent nature of the shaft creates an elliptical pattern. However, the problem with these prior art approaches is that the wiring needed to power the light must also follow the large elliptical movement of the light source. This creates stress in the wires which reduces the lifetime of the wiring. Furthermore, the bent shaft on the moving beam searchlight is fixed. Therefore, it is not possible to adjust the angle of the searchlight.

Another problem with certain spotlights currently in use is their use of slip rings. One reference which discusses the use of slip rings is U.S. Pat. No. 5,034,860 to Bryant et al. Slip rings are used to provide power to a spotlight which continuously rotates about an axis. In a slip ring arrangement, a spotlight has a series of pickup leads. The pickup leads provide power to the spotlight by continuously rotating with the spotlight about an electrically charged track. The slip rings overcome the problem of stressing the wires noted above. However, the disadvantage of a slip ring arrangement is the tendency of the slip rings to wear out and require replacement and at the very least require maintenance.

Therefore, there is a need for a light source which can rotate continuously about an axis without using a slip ring arrangement for power and can minimize stress on the electrical wiring. There is also a need for a light source which can operate at an adjustable angle.

### SUMMARY

The present invention solves the aforementioned problems by providing an apparatus for continuously sweeping a light source having an adjustable angle without the use of a slip ring arrangement. The present invention provides a light fixture assembly housing a light source which is continuously rotatable in a sweeping motion about a generally vertical axis of a base unit. The light fixture assembly contains a light fixture assembly plate and a rotatable plate assembly. The rotatable plate assembly is rotatably disposed about the light fixture assembly plate. A drive cage is also provided. The drive cage is rotatably disposed on the base unit for sweeping the light source about the generally vertical axis with respect to the base unit. The drive cage is also coupled to the rotatable plate assembly and adjusts a light source axis of the light source. An anti-rotational assembly is also provided. The anti-rotational assembly is coupled to the light fixture assembly and the base unit. The anti-rotational assembly prevents the light source from rotating about the light source axis with respect to the base unit, thereby eliminating the need for slip rings and reducing the stress placed on the wires supplying electricity to the light source from the base unit.

### BRIEF DESCRIPTION OF DRAWINGS

FIG. 1 shows an off-center cross section of the apparatus of the present invention.

FIG. 2a shows a perspective view of the base unit of the present invention with the sidewalls removed.

FIG. 2b shows a perspective view of the base unit of the present invention with the sidewalls removed.

FIG. 2c shows the first plate and the base plate assembly;

FIG. 2d shows an expanded view of the base plate assembly;

FIG. 2e shows a top view of the base unit and first cover plate and the opening of the first cover plate;

FIG. 3 shows a perspective view of the drive cage coupled to the first cover plate;

FIG. 4 shows a perspective view of the anti-rotational assembly;

FIG. 5a shows an off center cross section of the interior of the light fixture assembly and;

FIG. 5b shows the cross bar and light fixture assembly plate;

FIG. 5c shows the cover plate and the light source; and

FIG. 6 an off-center cross section of the present invention.

### DETAILED DESCRIPTION OF EMBODIMENTS

The present invention will now be described more fully hereinafter with reference to the accompanying drawings, in which preferred embodiments of the invention are shown. This invention may be embodied in many different forms and should not be construed as limited to the embodiments set forth herein.

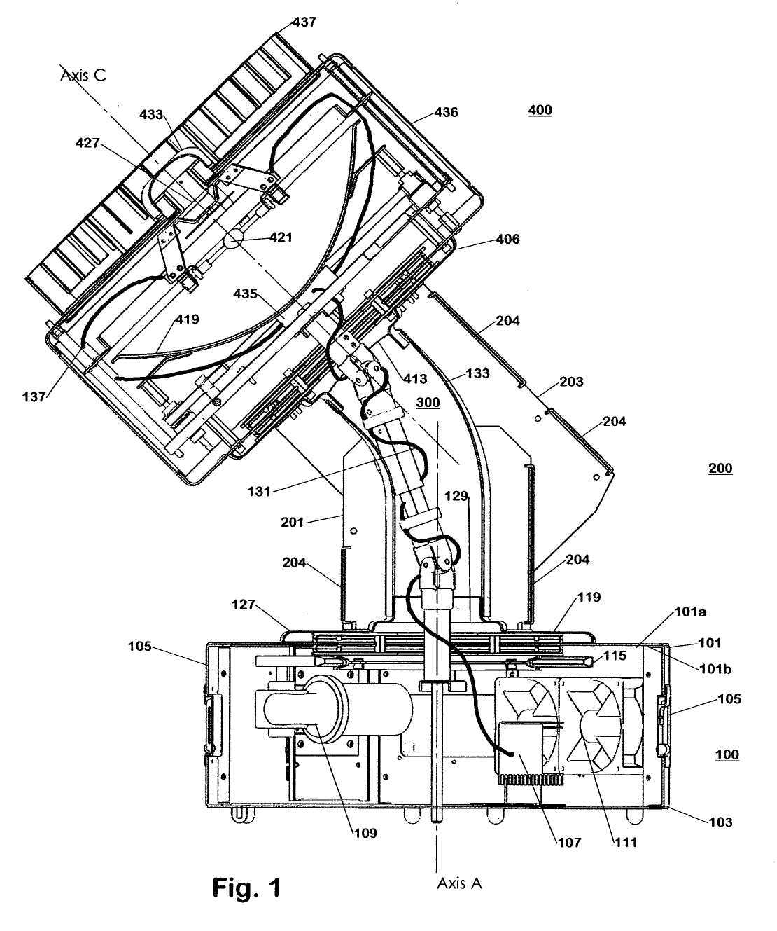

Referring to FIG. 1 an apparatus for a continuously rotatable light source is depicted. The apparatus includes a stationary base unit 100, a light fixture assembly 400, and a drive cage 200 rotatably coupled to the base unit 100 and rotatably coupled to the light fixture assembly 400. An anti-rotation assembly 300 is also provided. The anti-rotational assembly 300 is fixedly coupled to the base unit 100 and to the light fixture assembly 400. A generally vertical axis A is defined, which is orthogonal to and extends more or less centrally through the base unit 100 and through a first lower member 305 of the anti-rotational assembly 400. A light source axis C is also defined, which extends centrally through the light fixture assembly 400, the light source 421, and through a second upper member 313 of the anti-rotational assembly 300. The drive cage 200, which is comprised of a lower section 201 and an upper section 203, rotates the light fixture assembly 400 and the light source 421 about the vertical axis A with respect to the base unit 100, and thereby light source axis C sweeps out a conical shape. However, as the light fixture assembly 400 sweeps about the vertical axis A, the anti-rotational assembly 300 prevents the light fixture assembly 400 from rotating about the light source axis C, with respect to the base unit 100.

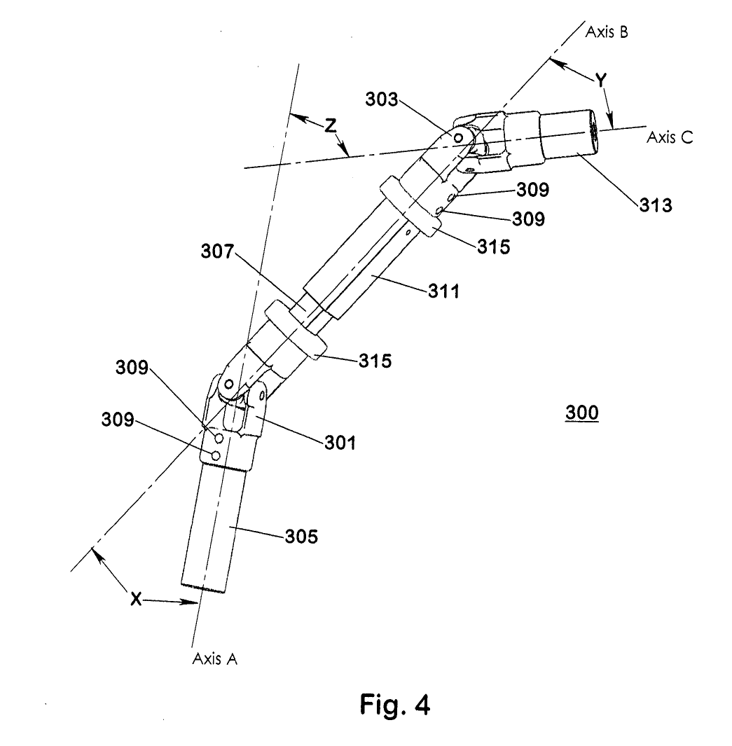

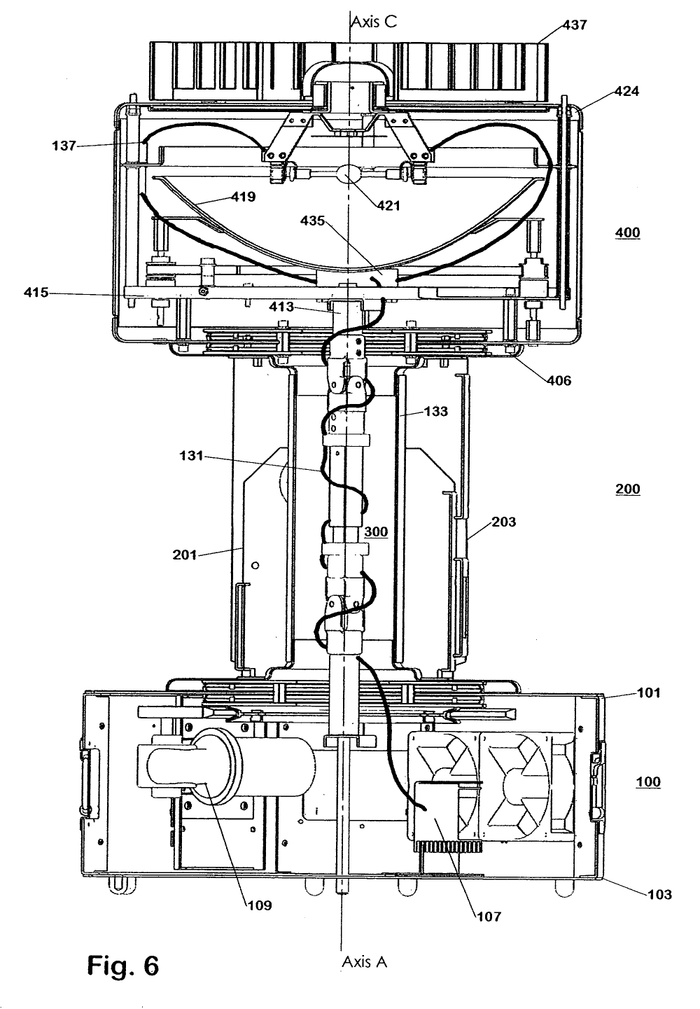

The foregoing description assumes that some angle “z” (See FIG. 4) other than 0°, exists between the vertical axis A and the light source axis C. If those two axes are collinear (i.e. z=0°, See FIG. 6), then the light fixture assembly 400 remains stationary relative to the base unit 100 even when the drive cage 200 rotates. However, as soon as an angle “z” greater than 0° but less than or equal to 90° occurs (by moving the lower section 201 and upper section 203 of the drive cage 200, as will be subsequently discussed), the light fixture assembly 400 and light source 421 make a sweeping movement without rotating about light source axis C relative to the base unit 100, in response to rotation of the drive cage 200. During the movement, light source axis C will sweep through a conical path.

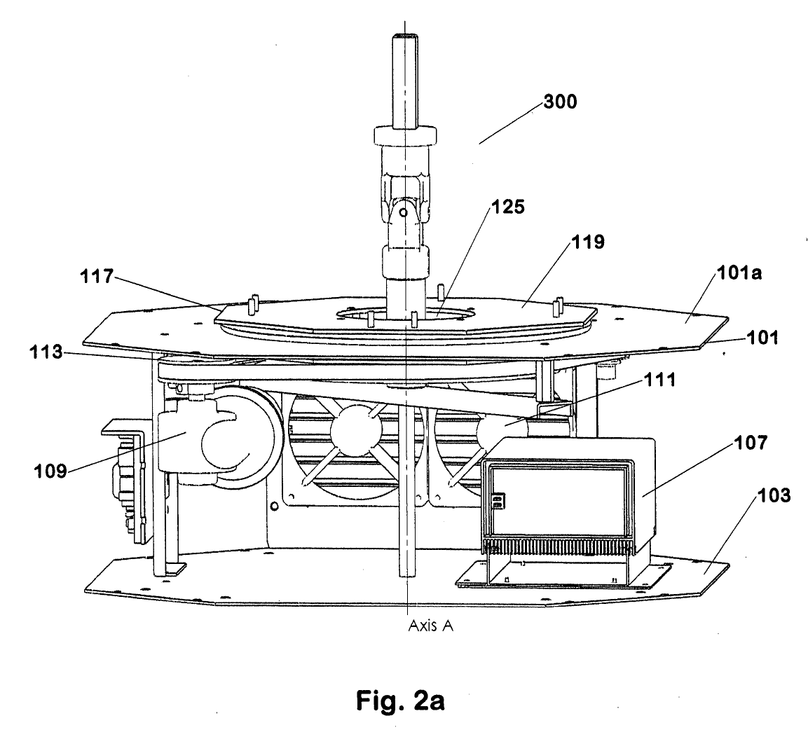

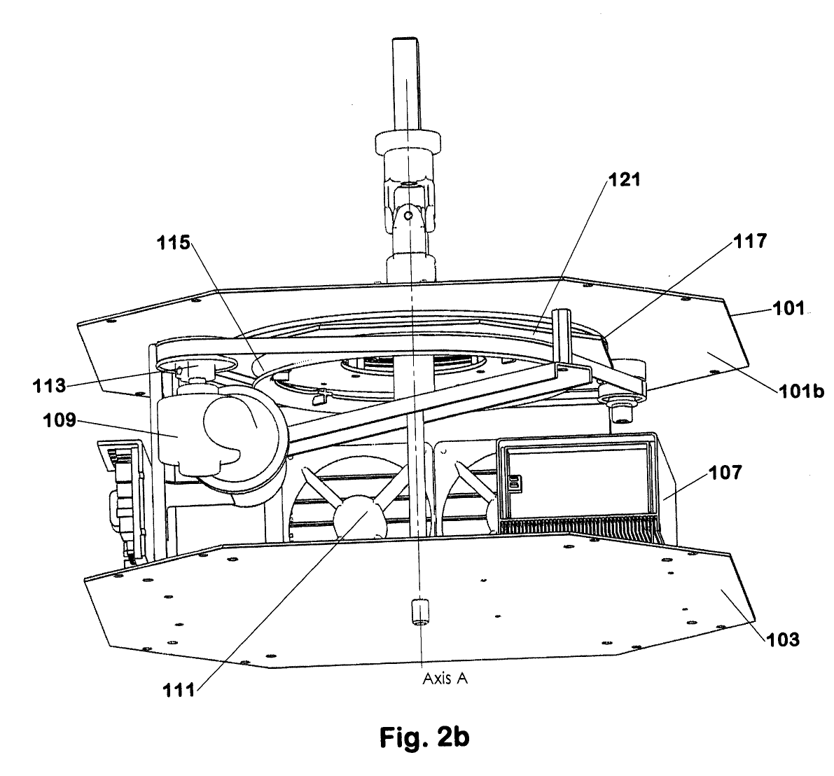

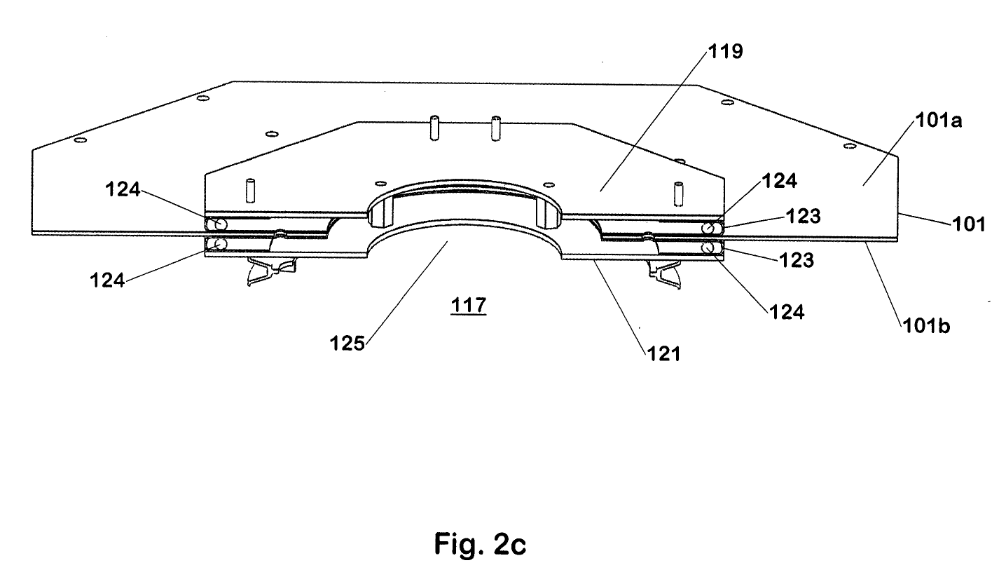

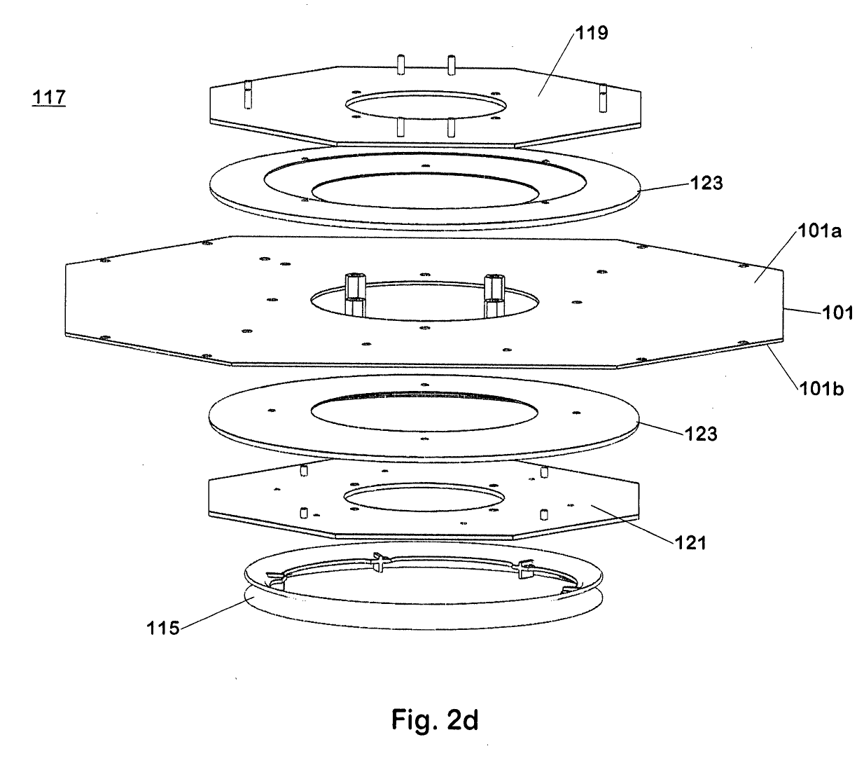

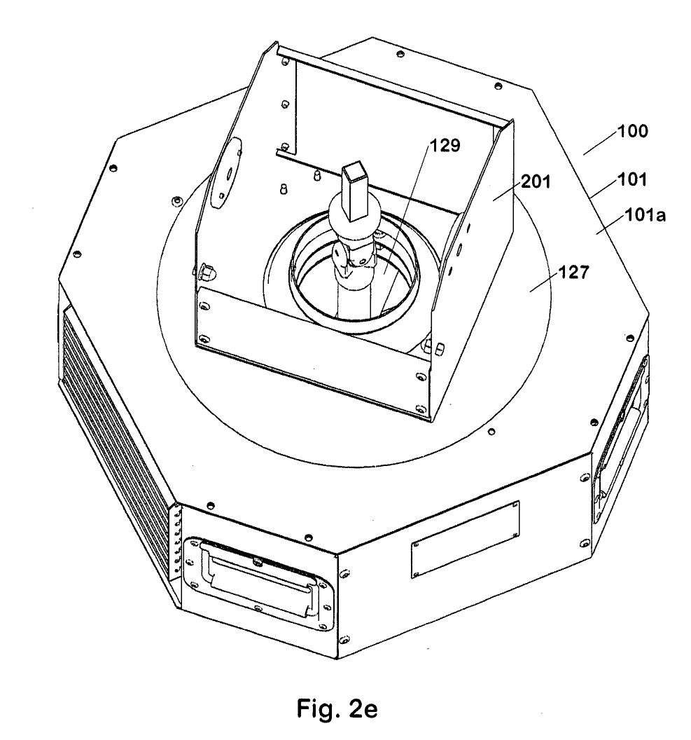

The stationary base unit 100 shown in FIG. 1 and in greater detail in FIGS. 2a and 2b is preferably comprise a first plate 101 and second plate 103 connected by sidewalls 105. The first plate 101 has a first surface 101a and a second surface 101b. The interior of the base unit 100 preferably houses a power source 107, a drive source 109 and a fan 111 for cooling the power source 107 and drive source 109. The power source 107 can be coupled to a readily available 120 VAC source which provides power to the drive source 109, fan 111, and light source 421 in the light fixture assembly 400. The drive source 109 preferably comprises a DC motor and variable speed controller to be used in conjunction with a belt drive system to cause rotation of the drive cage 200. Coupled to the drive source 109 is a drive pulley 113 that engages a second pulley 115 using a drive belt (not shown). The second pulley 115 is fixedly coupled to a base plate assembly 117 which is rotatably mounted to base unit 100, so that the drive source 109 can rotate the base plate assembly 117 and the drive cage 200 which is attached thereto.

The base plate assembly 117, shown in FIGS. 2c-2d is rotatably mounted to the first plate 101 using a thrust bearing arrangement 123. The thrust bearing arrangement 123 is shown best in FIG. 2c and 2d. The base plate assembly 117 is preferably comprises a first base plate 119 and a second base plate 121 coupled together, using nuts and bolts. The first base plate 119 extends over a portion of the first surface 101a and the second base plate 121 extends over a portion of the second surface 101b. Disposed between the first plate 101, the first base plate 119, and second base plate 121 are thrust bearings each containing a plurality of ball bearings 124. The thrust bearing arrangement 123 allows the base plate assembly 117 to rotate easily relative to the base plate 101, so that the drive source 109 can be used to rotate the base plate 117 and the drive cage 200 about the stationary base unit 100 along vertical axis A. The base plate assembly 117 also contains an opening 125 shown in FIG. 2a, which is in communication with the interior of the base unit 100. The vertical axis A extends centrally through the opening 125 as shown in FIG. 2a, for example.

A first cover plate 127 shown best in FIG. 1 and 2e is preferably mounted to the first base plate 119 using nuts and bolts, such that it extends over a portion of the first surface 101a, thereby hiding the details of the thrust bearing arrangement 123 from view. The first cover plate 127 helps prevent moisture or debris from entering the interior of the base unit 100 in the region where the first base plate 119 extends over the first surface 101a of the top plate 101 (See FIG. 2c). The first cover plate 127 is also disposed such that it rotates with the base plate assembly 117 about the base unit 100 and vertical axis A. The first cover plate 127 converges to the opening 129, which is directly above the opening 125 of the base plate assembly 117.

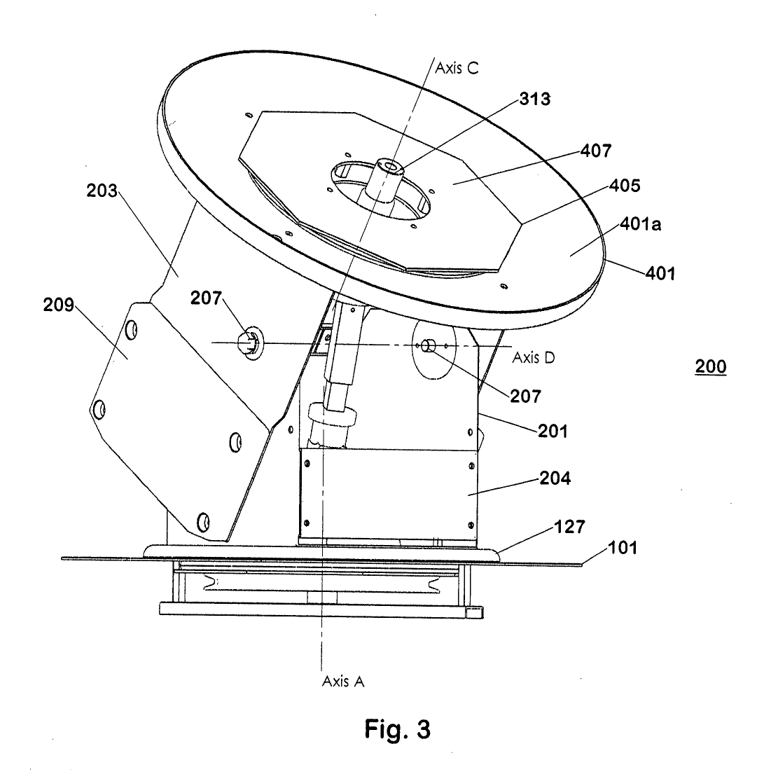

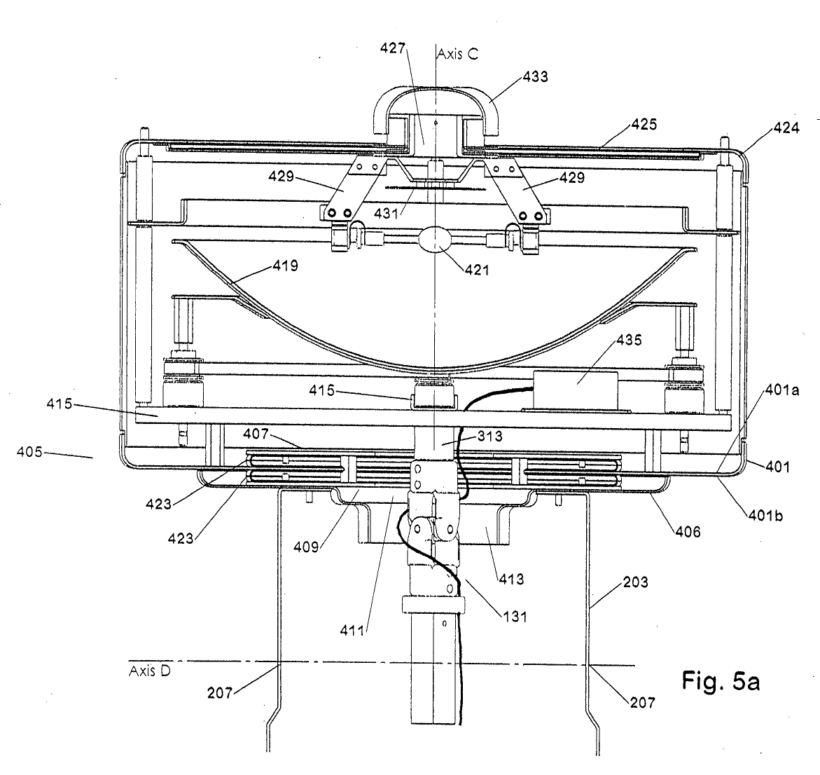

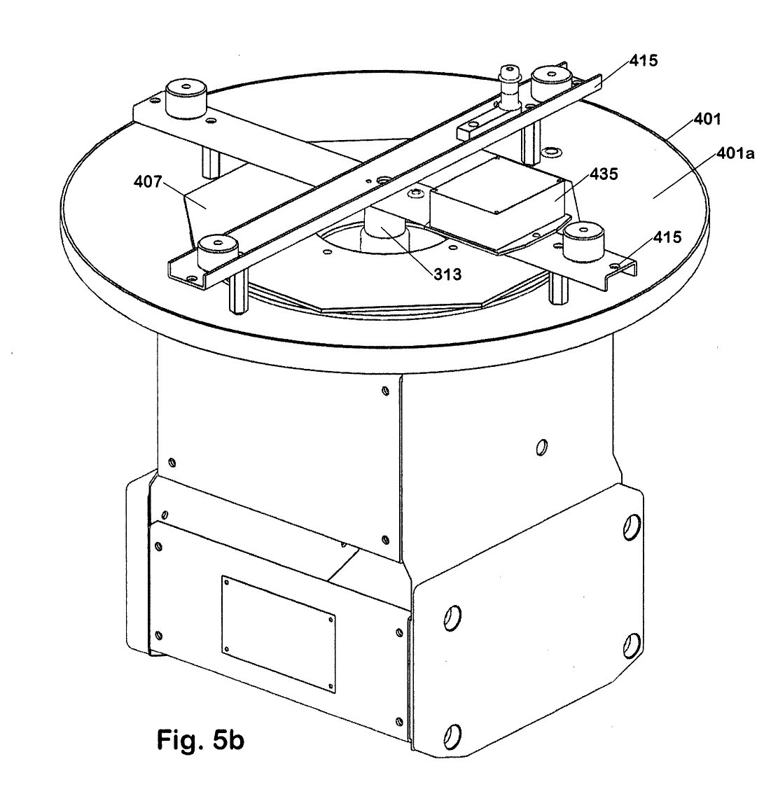

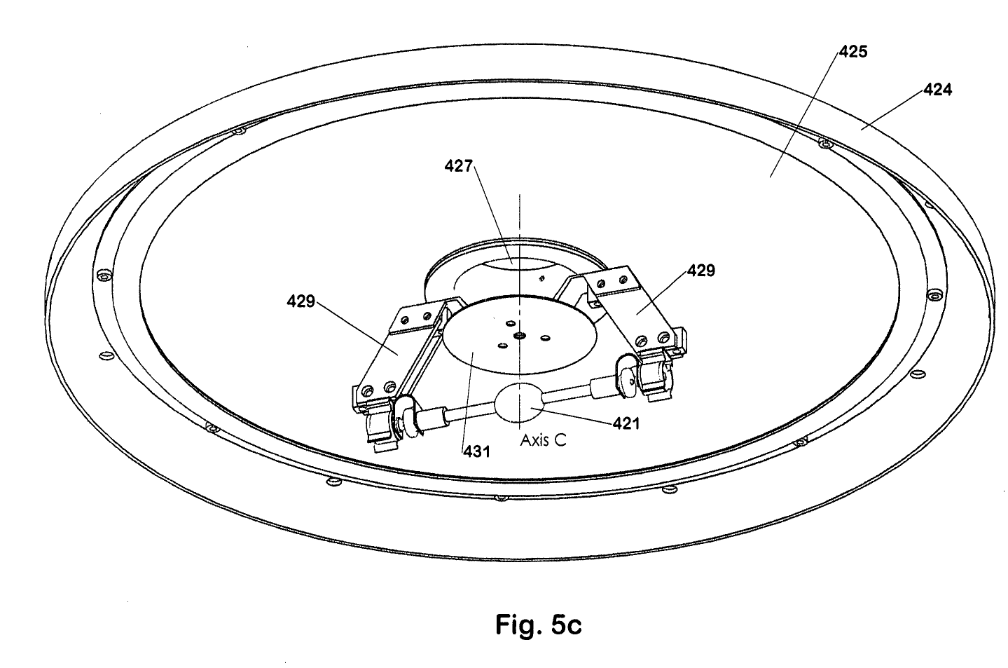

The drive cage 200 shown in FIGS. 1, 3, and 5a, is now described. The drive cage 200 has a lower section 201 and an upper section 203. The lower section 201 is fixedly mounted to the first cover plate 127, preferably using the same nuts and bolts used to couple the first cover plate 127 with the first base plate 119, such that it can rotate with the base plate 117 assembly about the base unit 100 and vertical axis A. The upper section 203 is pivotally coupled to the lower section 201 at pivot points 207 on a pivot axis D (See FIGS. 3 and 5a), such that the upper section 203 can adjust the angle of the light source axis C between a horizontal position (parallel to the first plate 101 of the base unit 100, 90° away from the vertical axis A) and a vertical position (parallel to the vertical axis A, 0° away from the vertical axis A), thereby allowing the angle of the light fixture assembly 400 and light source 421 relative to the base unit 100 to be adjusted. The lower section 201 also preferably includes a support member 204 to provide additional support when rotating the light fixture assembly 400. The upper section 203 is fixedly coupled to a second cover plate 406 (See also FIG. 5a) of the light fixture assembly 400. This allows the drive cage 200 to sweep the light fixture assembly 400 at a specified angle about the vertical axis A, thereby sweeping out a conical shape by light source axis C. Additionally, the upper section 203 preferably includes counterweights 209 (See FIG. 3) to help even the weight distribution of the light fixture assembly 400 relative to the base unit 100. The center of gravity of the upper section 203 and the light fixture assembly 400 is preferably on or very close to the pivot axis D.

Referring to FIG. 4, a detailed depiction of the anti-rotational assembly 300 is provided. The anti-rotation assembly 300 preferably includes a first u-joint 301 and a second u-joint 303. The first u-joint 301 is coupled between two members. A first lower member 305 and a first upper member 307 are each fixedly coupled to the first u-joint 301 using for example, set screws 309. The first lower member 305 extends through the opening 129 of the first cover plate 127 and the opening 125 of the base plate assembly 117 where it is coupled to the second plate 103 of the base unit 100 (See FIGS. 2a and 2b). The vertical axis A extends centrally through the first lower member 305, however, the first lower member 305 is prevented from rotating about the vertical axis A since it is fixedly coupled to the base unit 100. The first upper member 307 has an axis B, which is located centrally of and parallel to the first upper member 307. The first upper member 307 is free to pivot around the first lower section 305 when the axis B forms an adjustable angle “x”, shown in FIG. 4, with the vertical axis A at the intersection of the vertical axis A and the first axis B, wherein 0°<×≦45°. Furthermore, due to the nature of the first u-joint 301 and the fact that the first lower member 305 is firmly coupled to the base unit 100, the first upper member 307 can not rotate about its axis B.

The second u-joint 303 is also coupled with two members: a second lower member 311 and a second upper member 313. The second upper and lower members 311, 313 are each coupled to the second u-joint using for example, set screws 309. The second lower member 311 is hollow such that the first upper member 307 can be slidably removed from inside the second lower member 311 by using a spline type slider arrangement. When the drive cage 200 adjusts the angle of the light source axis C, the second lower member 311 will slide over the first upper member 307 towards or away from the first u-joint 301, depending on the adjustment of the angle. However, the first upper member 307 and second lower member 311 are provided, such that the second lower member 311 in adjusting the angle of the light source axis C, does not slide completely off the first upper member 307. The axis B is also located centrally of and parallel to the second lower member 311. The centerline of the second upper member 313 defines the light source axis C. The light source axis C is located centrally of and parallel to the second upper member 313. The second upper member 313 is free to pivot around the second lower member 311, when the light source axis C of the second upper member 313 forms an adjustable angle “y” shown in FIG. 4 with the axis B at the intersection of the axis B and the light source axis C, wherein 0°<y≦45°. In this way it is possible to pivot the second upper member 313 completely around the first lower member 305, sweeping out a conical shape, at a relative adjustable angle “z”, formed at the intersection of the light source axis C of the second upper member 313 and the vertical axis A of the first lower member 305, wherein 0<z≦90°. The second upper member 313 is also fixed to the light fixture assembly 400 as shown in FIG. 1. This allows the second upper member 313 to follow the contour of the drive cage 200, as the drive cage 200 sweeps the light fixture assembly 400 about the vertical axis A with respect to the base unit 100. Furthermore, due to the nature of the first and second u-joints 301, 303, as the second upper member 313 pivots around the first lower member 305 and the vertical axis A with respect to the base unit 100, the second upper member 313 is prevented from rotating about the light source axis C, and therefore does not rotate with respect to the base unit 100.

Finally, rubber pads 315 are preferably coupled to the first upper member 307 and second lower member 311. The rubber pads 315 contain a small hole (not shown) which is adapted to receive electrical wires 131 (discussed later) and help support and hold those electrical wires 131 which run from the base unit 100 to the light fixture assembly 400.

The anti-rotational assembly 300 could be provided with only one u-joint in order to simplify its construction. However, in such an embodiment, angle “z” would be limited to 45°, if two u-joints 301, 303 are utilized, then angle “z” can be as large as 90°. As such, we prefer to use two u-joints.

The light fixture assembly 400, is now discussed with reference to FIGS. 5a-5c. The light fixture assembly 400 includes a light fixture assembly plate 401 having a first plate surface 401a and a second plate surface 401b. A rotatable plate assembly 405 comprising a first rotatable plate 407 and second rotatable plate 409 is preferably provided. The first rotatable plate 407 and second rotatable plate 409 are fixedly coupled together using for example, nuts and bolts. The rotatable plate assembly 405 is coupled to the light fixture assembly plate 401 using a thrust bearing arrangement 423. This thrust bearing arrangement 423 is preferably the same arrangement 123 previously discussed to couple the base plate assembly 117 to the first plate 101 (See FIG. 2c and 2d). This allows the rotatable plate assembly 405 to rotate relative to the light fixture assembly plate 401. The rotatable plate assembly 405 also has an opening 411. A portion of the first rotatable plate 407 extends over a portion of the first plate surface 401a of and a portion of the second rotatable plate 409 extends over a portion of the second plate surface 401b.

A second cover plate 406 as previously discussed is provided. The second cover plate 406 is fixedly coupled the second rotatable plate 409, using for example, nuts and bolts, so that the second cover plate 406 can rotate with the second rotatable plate 409. The second cover plate 406 also preferably extends over a portion of second plate surface 401b, thereby hiding the details of the thrust bearing arrangement 423 from view. The second cover plate 406 helps prevent moisture or debris from entering the interior of the light fixture assembly 400, as seen in FIG. 5a. The second cover plate 406 converges into an opening 413 located directly below the opening 411 of the rotatable plate assembly 405. The upper section 203 of the drive cage 200 is fixedly coupled with the second cover plate 406, preferably using the nuts and bolts used to couple the second cover plate 406 with the second rotatable plate 409. The second upper member 313 of the anti-rotation assembly 300 extends through the opening 413 of the rotatable plate assembly 405 and the opening 411 of the rotatable plate assembly 405 where it is fixed to a cross bar 415 (See FIG. 5b). The cross bar 415 is fixed to the first plate surface 401a preferably as shown in FIG. 5b. A reflector 419 for the light source 421 is also preferably provided. Brackets 420 (See FIG. 5a) are used to couple the reflector 419 to the cross bar 415. The brackets 420 can preferably be adjusted to move the reflector towards or away from the light source 421 to focus light emitted from the light source 421.

A light source 421 is also provided, as shown in FIG. 5c. The light source 421 is preferably a 1200W metal halide lamp, however other light sources could be used. The light source axis C extends through the light source 421 such that light emitted from the light source 421 is generally along the light source axis C and away from the light fixture assembly 400. The light source 421 is mounted to a glass window 425 which, in turn, is mounted to a cover lip 424. Light from the light source 421 exits through the glass window 425. The glass window 425 is preferably comprised of a material which can remove UV rays from the light emitted by the light source 421. The cover lip 424 is coupled to the cross bar 415 using nuts and bolts, as shown in FIG. 5a. In this way, the light source 421 is effectively coupled to the second upper member 313 through the cover lip 424 and cross bar 415. As such, the light source 421 is prevented from rotating about the light source axis C with respect to the base unit 100. The center of the glass window 425 contains an opening 427 centrally located about the light source axis C as the light source assembly 400 sweeps out a conical path in response to the rotation of the drive cage 200. Mounting brackets 429 are coupled to the periphery of the opening 427 and used to support the light source 421. A heat shield 431 is also preferably provided between the opening 427 and light source 421. When the light source emits a beam of light, the heat shield 431 helps prevent the glass window 425 from becoming too hot. Also, the heat shield 431 helps prevent the majority of light from being concentrated in the middle of the emitted light. An igniter 435 is also preferably provided on the cross bar 415 (see FIG. 5b). The igniter 435 may be of any type, such as those commercially available from the Schiederwerk Co., which are used to generate the high voltage impulse needed to turn on metal halide light sources. The igniter 435 is coupled to the power source 107 with electrical wires 131, which preferably wrap around the anti-rotational assembly 300, as shown in FIG. 1 and 5a. The igniter 435 is then coupled to the light source 421 with a second set of wires 137 (See FIG. 1). Preferably, the second set of wires 137 are detachably coupled so that the light source 421 can be removed from the light fixture assembly 400, without having to remove the igniter 435. A debris shield 433, shown in FIG. 5a, is also preferably provided. The debris shield 433 is mounted around the periphery of the opening 427 to help prevent water and other debris from entering the opening 427, while allowing heat to escape from the light fixture assembly 400. A hollow shell 436 extending between the periphery of the light fixture assembly plate 401 and the cover lip 424 is also provided. The hollow shell 436 helps keep out stray light and prevent debris from entering the light fixture assembly 400. Finally, a baffle 437, shown best in FIGS. 1 and 6, is preferably provided. The baffle 437 is located over the glass window 425 about the debris shield 433 and helps prevent light from scattering in directions that are not generally parallel to the light source axis C.

Additionally, a flexible casing 133, as shown best in FIGS. 1 and 6 is preferably provided. The flexible casing 133 is mounted around the opening 129 of the first cover plate 127 and the opening 413 of the second cover plate 406 where it surrounds the electrical wires 131 and anti-rotational assembly 300. Air produced by the fan 111 in the base unit 100 is coupled through the casing 133 to the light fixture assembly 400 to cool the light source 421. The air then exits through the opening 427 in the glass window 425.

As previously discussed, FIG. 6 depicts the apparatus when the vertical axis A and light source axis C are collinear (i.e. z=0°). As aforementioned, the light source 421 is effectively coupled to the second upper member 313 of the anti-rotational assembly 300, and the light source axis C passes through the second upper member 313 and the light source 421. The drive source 109 and base plate assembly 117 rotate the drive cage 200. The upper section 203 of the drive cage 200 is coupled to the second cover plate 406, and sweeps the light fixture assembly 400 about the vertical axis A. However, because the light source 421 is effectively coupled to the second upper member 313, the light source 421 is prevented from rotating about the light source axis C and does not rotate with respect to the base unit. As a result, the upper section 203 of the drive cage 200 rotates the rotatable plate assembly 405 about the light fixture assembly plate 401, while the light fixture assembly 400 and the light source 421 do not rotate about the light source axis C with respect to the base unit 100. Since the light source 421 is prevented from rotating about the light source axis C, the light source 421 does not rotate with respect to the base unit 100, and only a finite length of electrical wire 131 is needed to power the light source 421 and still allow the drive cage 200 to continuously sweep the light fixture assembly 400 and light source 421 about the vertical axis A.

Let it be understood that the foregoing description is only illustrative of the invention. Various alternatives and modifications can be devised by those skilled in the art without departing from the spirit of the invention. Accordingly, the present invention is intended to embrace all such alternatives, modifications, and variances which fall within the scope of the appended claims.

What is claimed is:

1. An apparatus for continuously sweeping a light source, without rotating the light source relative to a stationary base unit, the apparatus comprising:
a light fixture assembly housing the light source and having a light source axis extending centrally therethrough, the light fixture assembly having a light fixture assembly plate with a rotatable plate assembly rotatably disposed thereon, wherein the light source is coupled to the light fixture assembly plate;
a drive cage coupled with the rotatable plate assembly and rotatably coupled to the base unit, the drive cage sweeping the light source about a generally vertical axis associated with the base unit; and
an anti-rotational assembly coupled to the base unit and to the light fixture plate, the anti-rotational assembly preventing the light source from rotating about the light source axis with respect to the base unit.

2. The apparatus of claim 1, further comprising a base plate assembly disposed on the base unit, the base plate assembly comprising a first base plate and second base plate coupled to the base unit with a thrust type bearing arrangement, wherein the drive cage is coupled with the first base plate.

3. The apparatus of claim 1, wherein the anti-rotational assembly comprises at least one u-joint.

4. The apparatus of claim 1, wherein the light fixture assembly further comprises a reflector located between the light fixture assembly plate and the light source for focusing light emitted by the light source.

5. The apparatus of claim 1, wherein the drive cage positions the light source axis anywhere between a horizontal position and a vertical position.

6. The apparatus of claim 2, wherein the rotatable plate assembly comprises a first rotatable plate and a second rotatable plate coupled to the light fixture assembly plate with a thrust type bearing arrangement.

7. The apparatus of claim 3, wherein the at least one u-joint further comprises a first u-joint and a second u-joint, the first u-joint coupling a first lower and upper member, the second u-joint coupling a second lower and upper member.

8. The apparatus of claim 7, wherein the first lower member is firmly coupled to the base unit and is located centrally of the vertical axis, the second upper member is coupled to the light fixture assembly and is located centrally of the light source axis, and wherein the second upper member can pivot completely around the first lower member at any angle greater than 0° and less than or equal to 90°.

9. The apparatus of claim 6, further comprising a first cover plate coupled with the first base plate and a second cover plate coupled with the second rotatable plate, the first cover plate in communication with the interior of the base unit and the second cover plate in communication with the light source.

10. The apparatus of claim 9, wherein the drive cage comprises a lower section and an upper section, the lower section coupled with the first cover plate, and the upper section coupled with the second cover plate, the upper section pivotaly connected to the lower section at a pivot axis to position the light source axis anywhere between a vertical position and a horizontal position, and wherein the lower section includes at least one counterweight.

11. The apparatus of claim 9, wherein the base unit houses a drive source for rotating the base plate assembly, a power supply supplying power to the drive source and the light source, and a fan producing air for cooling the power supply and the drive source.

12. The apparatus of claim 11, further comprising a flexible casing coupled between the first cover plate and second cover plate, wherein air produced by the fan in the base unit is coupled through the flexible casing to the light fixture assembly to cool the light source.

13. The apparatus of claim 12, wherein the light fixture assembly comprises a glass window through which light emitted from the light source exits, the glass window having an opening for allowing air used to cool the light source to escape.

14. A method for continuously sweeping a light source, without rotating the light source relative to a stationary base unit, comprising the steps of:
sweeping the light source about a generally vertical axis associated with the base unit, thereby sweeping out a conical shape about the vertical axis; and
preventing the light source from rotating about a light source axis with respect to the base unit.

15. The method of claim 14, further comprising the step of adjusting the light source axis thereby adjusting the angle of the light source anywhere between a horizontal position and a vertical position.

16. An apparatus for continuously sweeping a light source, without rotating the light source relative to a stationary base unit, the apparatus comprising:
a light fixture assembly housing the light source source and having a light source axis extending centrally therethrough;
a drive cage rotatably coupled to the base unit and rotatably coupled to the light fixture assembly, the drive cage sweeping the light source about a generally vertical axis associated with the base unit; and
an anti-rotational assembly coupled to the base unit and to the light fixture assembly, the anti-rotational assembly preventing the light source from rotating about the light source axis with respect to the base unit.

17. The apparatus of claim 16, wherein the light fixture assembly comprises a light fixture assembly plate and a rotatable plate assembly rotatably disposed thereon, wherein the light source is coupled to the light fixture assembly plate.

18. The apparatus of claim 17, further comprising a base plate assembly disposed on the base unit, the base plate assembly comprising a first base plate and second base plate coupled to the base unit with a thrust type bearing arrangement, wherein the drive cage is coupled with the first base plate.

19. The apparatus of claim 16, wherein the anti-rotational assembly comprises at least one u-joint.

20. The apparatus of claim 17, wherein the light fixture assembly further comprises a reflector located between the light fixture assembly plate and the light source for focusing light emitted by the light source.

21. The apparatus of claim 16, wherein the drive cage position the light source axis anywhere between a horizontal position and a vertical position.

22. The apparatus of claim 18, wherein the rotatable plate assembly comprises a first rotatable plate and a second rotatable plate coupled to the light fixture assembly plate with a thrust type bearing arrangement.

23. The apparatus of claim 19, wherein the at least one u-joint further comprises a first u-joint and a second u-joint, the first u-joint coupling a first lower and upper member, the second u-joint coupling a second lower and upper member.

24. The apparatus of claim 23, wherein the first lower member is firmly coupled to the base unit and is located centrally of the vertical axis, the second upper member is coupled to the light fixture assembly and is located centrally of the light source axis, and wherein the second upper member can pivot completely around the first lower member at any angle greater than 0° and less than or equal to 90°.

25. The apparatus of claim 22, further comprising a first cover plate coupled to the first base plate and a second cover plate coupled to the second rotatable plate, the first cover plate in communication with the interior of the base unit and the second cover plate in communication with the light source.

26. The apparatus of claim 25, wherein the drive cage comprises a lower section and an upper section, the lower section coupled with the first cover plate, and the upper section coupled with the second cover plate, the upper section pivotally connected to the lower section at a pivot axis to position the light source axis anywhere between a vertical position and a horizontal position, and wherein the lower section includes at least one counterweight.

27. The apparatus of claim 26, wherein the base unit houses a drive source for rotating the base plate assembly, a power supply supplying power to the drive source and the light source, and a fan producing air for cooling the power supply and the drive source.

28. The apparatus of claim 27, further comprising a flexible casing coupled between the first cover plate and second cover plate, wherein air produced by the fan in the base unit is coupled through the flexible casing to the light fixture assembly to cool the light source.

29. The apparatus of claim 28, wherein the light fixture assembly comprises a glass window through which light emitted from the light source exits, the glass window having an opening for allowing air used to cool the light source to escape.

30. An apparatus for continuously sweeping a light source, without rotating the light source relative to a stationary base unit, the apparatus comprising:
a light fixture assembly housing the light source and having a light source axis extending centrally therethrough;
a drive cage sweeping the light source about a generally vertical axis associated with the base unit, thereby sweeping out a conical shape about the vertical axis; and
an anti-rotational assembly preventing the light source from rotating about the light source axis with respect to the base unit.

31. The apparatus of claim 30, wherein, the drive cage is rotatably coupled to the base unit and rotatably coupled to the light fixture assembly.

32. The apparatus of claim 31, wherein the light fixture assembly includes a light fixture assembly plate and a rotatable plate assembly.

33. The apparatus of claim 32, wherein the base unit includes a base plate assembly disposed on the base unit, the base plate assembly comprising a first base plate and second base plate coupled to the base unit with a thrust type bearing arrangement, wherein the drive cage is coupled with the first base plate.

34. The apparatus of claim 30, wherein the anti-rotational assembly comprises at least one u-joint.

35. The apparatus of claim 32, wherein the light fixture assembly further comprises a reflector located between the light fixture assembly plate and the light source for focusing light emitted by the light source.

36. The apparatus of claim 30, wherein the drive cage adjusts positions the light source axis anywhere between a horizontal position and a vertical position.

37. The apparatus of claim 33, wherein the rotatable plate assembly comprises a first rotatable plate and a second rotatable plate coupled to the light fixture assembly plate with a thrust type bearing.

38. The apparatus of claim 34, wherein the at least one u-joint further comprises a first u joint and a second u-joint, the first u-joint coupled with a first lower and upper member, the second u-joint coupled with a second lower and upper member.

39. The apparatus of claim 38, wherein the first lower member is firmly coupled to the base unit and is located centrally of the vertical axis, the second upper member is coupled to the light fixture assembly and is located centrally of the light source axis, and wherein the second upper member can pivot completely around the first lower member at any angle greater than 0° and less than or equal to 90°.

40. The apparatus of claim 37, further comprising a first cover plate coupled to the first base plate and a second cover plate coupled to the second rotatable plate, the first cover plate in communication with the interior of the base unit and the second cover plate in communication with the light source.

41. The apparatus of claim 40, wherein the drive cage comprises a lower section and an upper section, the lower section coupled with the first cover plate, and the upper section coupled with the second cover plate, the upper section pivotally connected to the lower section at a pivot axis to position the light source axis anywhere between a horizontal position and a vertical position, wherein the drive cage includes at least one counterweight.

42. The apparatus of claim 41, wherein the base unit houses a drive source for rotating the base plate assembly, a power supply supplying power to the drive source and the light source, and a fan producing air for cooling the power supply and the drive source.

43. The apparatus of claim 42, further comprising a flexible casing coupled between the first cover plate and second cover plate, wherein air produced by the fan in the base unit is coupled through the flexible casing to the light fixture assembly to cool the light source.

44. The apparatus of claim 43, wherein the light fixture assembly comprises a glass window through which light emitted from the light source exits, the glass window having an opening for allowing air used to cool the light source to escape.
